(19) United States
(12) Patent Application Publication
(10) Pub. No.: US 2021/0086553 A1
(43) Pub. Date: Mar. 25, 2021

(54) SPOKES OF WHEEL

(71) Applicant: SHENG I FIRST CO., LTD., Changhua County (TW)

(72) Inventor: Chin-Tsai TSAI, Changhua County (TW)

(21) Appl. No.: 16/934,674

(22) Filed: Jul. 21, 2020

(30) Foreign Application Priority Data
Sep. 19, 2019 (TW) 108212393

(51) Int. Cl. B60B 1/02; B60B 1/04

(52) U.S. Cl. CPC B60B 1/0253; B60B 2360/102; B60B 1/042; B60B 1/0284

(57) ABSTRACT

Spokes of a wheel contain: a wheel rim, a hub, multiple screwing segments, and multiple screw elements. The respective spoke is made of chrome molybdenum (Cr—Mo), and the respective spoke includes a through hole passing therethrough so as to form a seamless alloy steel pipe. The respective spoke includes a first connection segment and a second connection segment, the first connection segment has a first threaded section, and the second connection segment has a second threaded section so that the first threaded section is screwed with the respective screw element of the hub. The respective screw element of the hub has an orifice, such that the first threaded section is inserted through the orifice to screw with the respective screw element on an inner wall of the hub, and the second threaded section is screwed with the respective screwing segment of the wheel rim.

### FIELD OF THE INVENTION

The present invention relates to spokes of a wheel which are flexible to absorb vibration, expand easily, and are compact

### BACKGROUND OF THE INVENTION

A conventional bicycle wheel are expended and supported by multiple spokes. When riding on a rough road, a wheel rim of the bicycle wheel deforms easily, and the spokes distort.

The spokes are not heat treated and are made of stainless steel, so they are broken easily. In addition, a curved segment and a screwing segment of the respective spoke and are damaged because of stress concentration. The respective spoke is elongated to bend laterally and cause deflection, thus destroying the respective spoke.

The present invention has arisen to mitigate and/or obviate the afore-described disadvantages.

### SUMMARY OF THE INVENTION

The primary objective of the present invention is to provide spokes of a wheel which are made of alloy material, such as chrome molybdenum (Cr—Mo), and the respective spoke includes the through hole passing therethrough so as to form the respective spoke as the seamless alloy steel pipe, wherein the respective spoke is modified in the heat treatment manner so that the respective spoke is flexible to absorb vibration, expands, and is compact.

To obtain the above mentioned objective, spokes of a wheel provided by the present invention contains:

a wheel rim, a hub fixed on a center of the wheel rim, multiple screwing segments arranged around an inner side of the wheel rim, and multiple screw elements mounted beside the hub and corresponding to the multiple screwing segments. A respective screw element is connected with a respective screwing segment via a respective spoke so as to fix the hub and the wheel rim.

The respective spoke is made of chrome molybdenum (Cr—Mo), and the respective spoke includes a through hole passing therethrough so as to form a seamless alloy steel pipe.

The respective spoke includes a first connection segment and a second connection segment, the first connection segment has a first threaded section roll formed on an outer wall thereof, and the second connection segment has a second threaded section roll formed on an outer wall thereof so that the first threaded section is screwed with the respective screw element of the hub. The respective screw element of the hub has an orifice, such that the first threaded section is inserted through the orifice to screw with the respective screw element on an inner wall of the hub, and the second threaded section is screwed with the respective screwing segment of the wheel rim.

### BRIEF DESCRIPTION OF THE DRAWINGS

FIG. 1 is a perspective view showing the application of spokes of a wheel according to a preferred embodiment of the present invention.

FIG. 2 is a perspective view showing the assembly of a respective spoke according to the preferred embodiment of the present invention.

FIG. 3 is a cross sectional view showing the assembly of the respective spoke according to the preferred embodiment of the present invention.

### DETAILED DESCRIPTION OF THE PREFERRED EMBODIMENTS

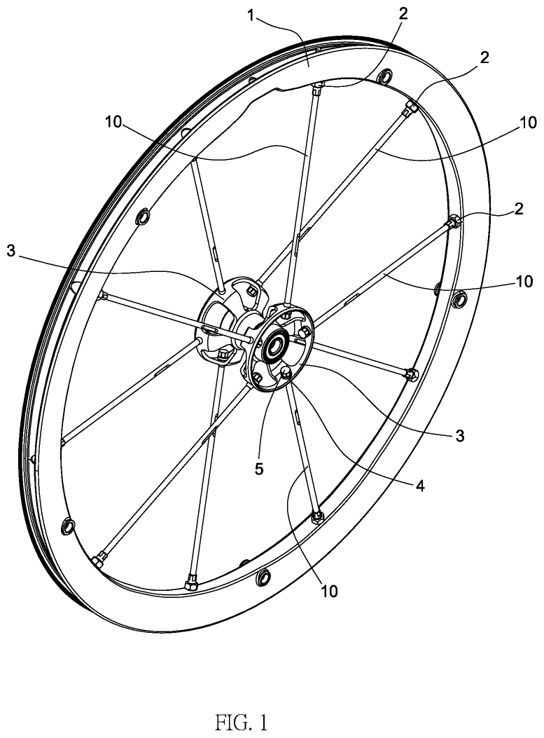

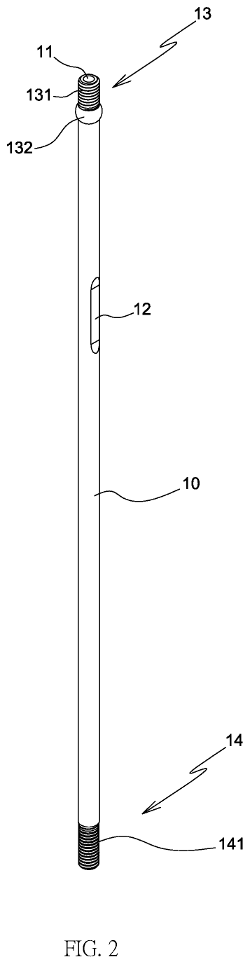

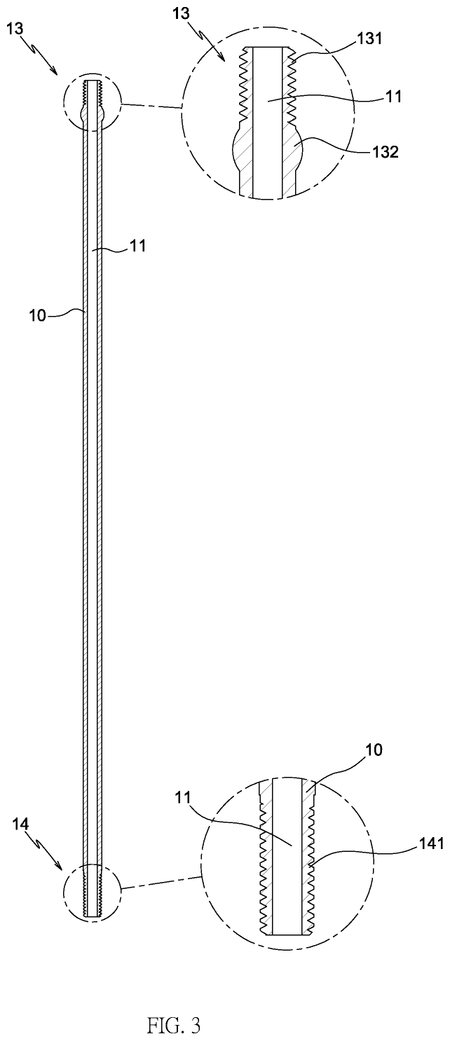

With reference to FIGS. 1-3, spokes 10 of a wheel according to a preferred embodiment of the present invention comprises:

a wheel rim 1, a hub 3 fixed on a center of the wheel rim 1, multiple screwing segments 2 arranged around an inner side of the wheel rim 1, and multiple screw elements 5 mounted beside the hub 3 and corresponding to the multiple screwing segments 2, wherein a respective screw element 5 is connected with a respective screwing segment 2 via a respective spoke 10 so as to fix the hub 3 and the wheel rim 1.

The respective spoke 10 is made of alloy material, such as chrome molybdenum (Cr—Mo), and the respective spoke 10 includes a through hole 11 passing therethrough so as to form a seamless alloy steel pipe, wherein the respective spoke 10 is modified in a heat treatment manner so that the respective spoke 10 is flexible to absorb vibration, expands easily, and is compact.

The respective spoke 10 includes a first connection segment 13 and a second connection segment 14, wherein the first connection segment 13 has a first threaded section 131 roll formed on an outer wall thereof, and the second connection segment 14 has a second threaded section 141 roll formed on an outer wall thereof so that the first threaded section 131 is screwed with the respective screw element 5 of the hub 3, wherein the respective screw element 5 of the hub 3 has an orifice 4, such that the first threaded section 131 is inserted through the orifice 4 to screw with the respective screw element 5 on an inner wall of the hub 3, and the second threaded section 141 is screwed with the respective screwing segment 2 of the wheel rim 1.

Preferably, the respective spoke 10 includes at least two drive planes 12, and a respective drive plane 12 is formed on a predetermined position of the respective spoke 10 and is configured to drive the respective spoke 10 to rotate by ways of a hand tool, thus adjusting the wheel rim 1 and the hub 3 loosely or tightly.

The first connection segment 13 of the respective spoke 10 has a stop rib 132 connected with the first threaded section 131, when the first threaded section 131 is inserted through the orifice 4, the stop rib 132 engages with an outer wall of the hub 3, and the first threaded section 131 is screwed with the respective screw element 5 on the inner wall of the hub 3, thus fixing the first threaded section 131 securely.

The respective spoke 10 is made of alloy material, such as chrome molybdenum (Cr—Mo), and the respective spoke 10 includes the through hole 11 passing therethrough so as to form the seamless alloy steel pipe, wherein the respective spoke 10 is modified in the heat treatment manner so that the respective spoke 10 is flexible to absorb vibration, expands easily, and is compact.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. Spokes of a wheel comprising:
a wheel rim, a hub fixed on a center of the wheel rim, multiple screwing segments arranged around an inner side of the wheel rim, and multiple screw elements mounted beside the hub and corresponding to the multiple screwing segments, wherein a respective screw element is connected with a respective screwing segment via a respective spoke so as to fix the hub and the wheel rim;
wherein the respective spoke is made of chrome molybdenum (Cr—Mo), and the respective spoke includes a through hole passing therethrough so as to form a seamless alloy steel pipe;
wherein the respective spoke includes a first connection segment and a second connection segment, the first connection segment has a first threaded section roll formed on an outer wall thereof, and the second connection segment has a second threaded section roll formed on an outer wall thereof so that the first threaded section is screwed with the respective screw element of the hub, wherein the respective screw element of the hub has an orifice, such that the first threaded section is inserted through the orifice to screw with the respective screw element on an inner wall of the hub, and the second threaded section is screwed with the respective screwing segment of the wheel rim.

2. The spokes as claimed in claim 1, wherein the respective spoke includes at least two drive planes, and a respective drive plane is formed on a predetermined position of the respective spoke.

3. The spokes as claimed in claim 1, wherein the first connection segment of the respective spoke has a stop rib connected with the first threaded section.
